(19) United States
(12) Patent Application Publication
(10) Pub. No.: US 2023/0072943 A1
(43) Pub. Date: Mar. 9, 2023

(54) UTILITY KNIFE

(71) Applicants: Andres Hausmann, Ft. Lauderdale, FL (US); Eduardo Saias, Ft. Lauderdale, FL (US); David Morgenstern, Ft. Lauderdale, FL (US); Leonardo Lustgarten, Ft. Lauderdale, FL (US)

(72) Inventors: Andres Hausmann, Ft. Lauderdale, FL (US); Eduardo Saias, Ft. Lauderdale, FL (US); David Morgenstern, Ft. Lauderdale, FL (US); Leonardo Lustgarten, Ft. Lauderdale, FL (US)

(21) Appl. No.: 17/941,826

(22) Filed: Sep. 9, 2022

Related U.S. Application Data
(60) Provisional application No. 63/242,353, filed on Sep. 9, 2021.

(51) Int. Cl. B26B 5/00; B25G 1/08; B25G 1/10

(52) U.S. Cl. CPC B26B 5/005; B25G 1/08; B25G 1/102; B26B 5/003

(57) ABSTRACT

A utility knife is disclosed, including a housing having a handle portion and a front end. A first wing and a second wing are each pivotally engaged with the handle portion. The first wing and the second wing guide at least one blade along an edge of a box when cutting and disassembling the box. A trigger extends and retract the at least one blade such that the blade(s) are only extended during use to protect the user.

### CROSS-REFERENCE TO RELATED APPLICATIONS

The present application claims priority to U.S. Provisional Patent Application No. 63/242,353 filed Sep. 9, 2021, entitled “UTILITY KNIFE” which is hereby incorporated by reference in its entirety.

### TECHNICAL FIELD

Embodiments of the invention relate to utility knives and more particularly to box cutters having extendable blades.

### BACKGROUND

Utility knives are often used for general work purposes. Originally, such knives were constructed having fixed blades with durable cutting edges suitable for various projects. More recently, utility knives have been designed which have folding, retractable, and/or replaceable cutting blades. Knives having retractable and replaceable blades use die-cast metal or standardized razor blades. The blades can be selectively extended and locked into position. This prevents the blade from being over-extended and allows the user to cut through a layer of material (e.g., a cardboard box) without cutting the contents therein. When the blade becomes dull, it can be quickly reversed and/or replaced.

Of course, safety is always a concern when using box cutters, scissors, and other cutting elements. Further, while various cutting elements may be useful, they are not specifically designed for cutting and disassembling boxes.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a utility knife, including a housing having a handle portion and a front end. A first wing and a second wing are each pivotally engaged with the handle portion. The first wing and the second wing guide at least one blade along an edge of a box when cutting and disassembling the box. A trigger extends and retract the blade such that the blade(s) are only extended during use to protect the user.

The embodiments describe a utility knife which can be utilized to cut and disassemble boxes and provide a safe alternative to otherwise dangerous utility knifes known in the ails. The utility knife provides a safe and efficient means for a user to cut a cardboard box, or similar packaging implement. The utility knife is handheld and has an ergonomic design such that the user can comfortably utilize the device throughout long periods of use. The utility knife can allow the user to safely open the box tape or slice open all sides of the box along each corner such that the volume of the box is reduced, increasing the number of boxes which can be stored, discarded, or transported.

Each wing guides the user along the edges of the box to ensure the blade makes an accurate cut to disassemble the box in an efficient manner. Each wing also protects the user from the extended blade, whereas the utility knives in the current arts expose the blade creating a potential hazard to the user.

In one aspect, the handle is comprised of an interior cavity to house one or more replacement blades.

In one aspect, the interior cavity is selectively accessed by a release button positioned on the handle portion.

In one aspect, the first wing and the second wing are pivotally engaged with the handle portion.

In one aspect, the at least one blade include a primary cutting blade and a tape cutting blade, wherein the primary cutting blade is dimensioned to cut cardboard, and wherein the tape cutting blade is dimensioned to cut tape.

In one aspect, the handle is ergonomically designed to provide increased comfort during long periods of use.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a perspective view of the utility knife which may be utilized to cut and disassemble boxes, according to some embodiments;

FIG. 2 illustrates a perspective view of the bottom side of the utility knife, wherein the blade is in a retracted position, according to some embodiments;

FIG. 3 illustrates a perspective view of the bottom side of the utility knife, wherein the blade is in an extended position, according to some embodiments; and

FIG. 4 illustrates a perspective view of the utility knife while in-use, wherein the user is cutting and/or disassembling a box, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a utility knife which can be utilized to cut and disassemble boxes. The utility knife provides a safe and efficient means for a user to cut a cardboard box, or similar packaging implement. The utility knife is handheld and has an ergonomic design such that the user can comfortably utilize the device throughout long periods of use. The utility knife can allow the user to safely open the box tape or slice open all sides of the box along each corner such that the volume of the box is reduced, increasing the number of boxes which can be stored, discarded, or transported.

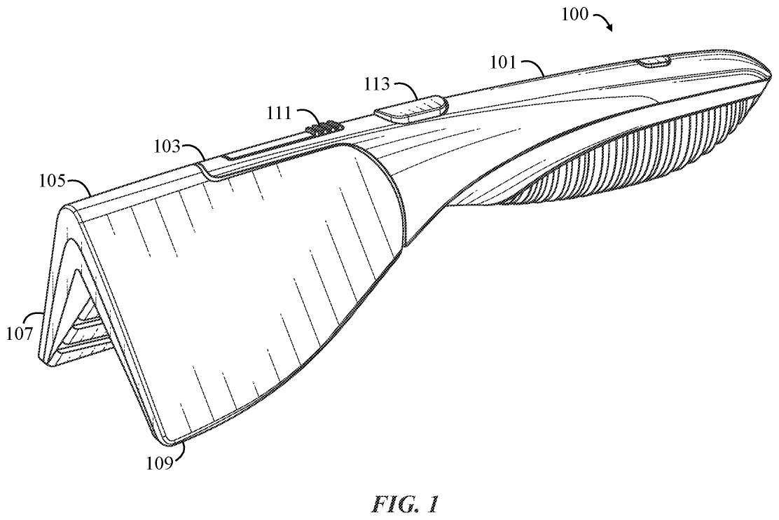

FIG. 1 illustrates a perspective view of the utility knife 100 which may be utilized to cut and disassemble boxes. The utility knife 100 includes a handle portion 101 which is ergonomically designed to provide comfort to the user. The handle portion 101 includes an interior cavity within a housing 103 which may store additional cutting blades. The housing includes the handle portion 101 and front portion 105 which comprises a first and a second wing 107,109. Each wing 107,109 guides the utility knife 100 along the edges of a box when cutting. Further, each wing 107,109 protects the user from accidentally contacting the blade during use. A blade release 111 is provided to allow the user to selectively engage and disengage the cutting blade. The blade release 111 is in communication with a locking mechanism which locks the blade within the housing 103 and retains the blade in position while cutting and during storage. One or more triggers 113 extend and retract a primary cutting blade and a tape cutting blade.

In some embodiments, the handle portion 101 is pivotally engaged to the first and second wing 107, 109. This creates an ergonomic design which is comfortable to the user throughout long periods of use.

In some embodiments, each wing 107,109 extends at an angle from one another such that the angle is sufficient to receive a box edge and glide along the edge of the box. This allows the user to safely and efficiently cut and disassemble the box by protecting the user from contacting the blade and guiding the user along the edge of the box to prevent slipping, missed cuts, etc.

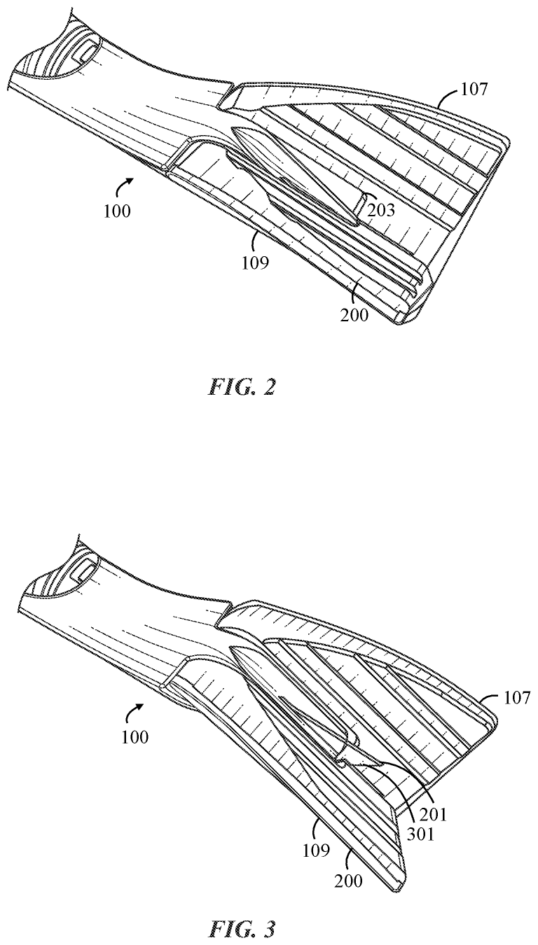

FIG. 2 and FIG. 3 illustrates a perspective view of the bottom side 200 of the utility knife 100, wherein the blade 201 (see FIG. 3) is in a retracted position 203 (as shown in FIG. 2) and an extended position 301 (as shown in FIG. 3). One skilled in the arts will readily understand that one or more knifes may be positioned on the bottom side 200 of the utility knife 100. This may allow for various blade sizes and configurations to be utilized for various projects. For example, a primary cutting blade may be utilized to cut cardboard or other more resilient material wherein a deeper cut is required. A smaller blade may be utilized for tape or likewise materials which only require a shallow cut to be made. Varying blade sizes and configurations allow the user to deconstruct items of various sizes which are held together by various materials without the need to utilize more than one cutting device. The utility knife described by the embodiments herein provides a safe and efficient means of deconstructing boxes and similar items and may be used in the home or for industrial purposes.

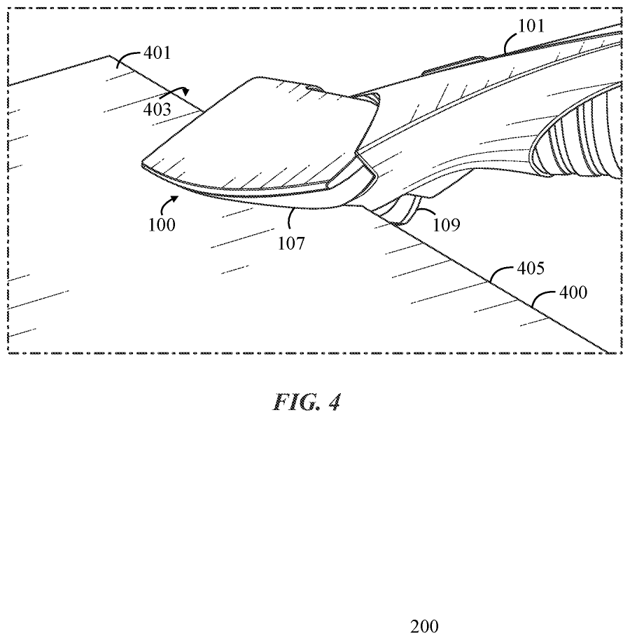

FIG. 4 illustrates a perspective view of the utility knife 100 while in-use, wherein the user is cutting and/or disassembling a box 400. The wings 107,109 are positioned such that the first wing 107 contacts a first side 401 of the box 400 and the second wing 109 contacts the second side 403 of the box 400. In some embodiments, each wing 107,109 may pivot to allow the handle 101 and wings 107,109 to articulate. The pivoting action provides a more comfortable position of the handle 101 while sliding along the edge 405 of the box 400 or while performing other cuts when disassembling the box 400. During use, the user will press one or more of the triggers to extend the blade, thus permitting the blade to cut the components of the box (e.g., the cardboard, tape, etc.).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A utility knife, comprising:
a housing including a handle portion and a front portion;
a first wing and a second wing extending from the handle portion, the first wing and the second wing to guide at least one blade along an edge of a box.

2. The utility knife of claim 1, wherein the handle is comprised of an interior cavity to house one or more replacement blades.

3. The utility knife of claim 1, wherein the first wing and the second wing are pivotally engaged with the handle portion.

4. The utility knife of claim 1, wherein the at least one blade include a primary cutting blade and a tape cutting blade.

5. The utility knife of claim 1, wherein the handle is ergonomically designed.

6. A utility knife, comprising:
a housing including a handle portion and a front portion;
a first wing and a second wing each pivotally engaged with the handle portion, the first wing and the second wing to guide at least one blade along an edge of a box; and
a trigger to extend and retract the at least one blade.

7. The utility knife of claim 6, wherein the handle is comprised of an interior cavity to house one or more replacement blades.

8. The utility knife of claim 7, wherein the interior cavity is selectively accessed by a release button positioned on the handle portion.

9. The utility knife of claim 7, wherein the first wing and the second wing are pivotally engaged with the handle portion.

10. The utility knife of claim 7, wherein the at least one blade include a primary cutting blade and a tape cutting blade, wherein the primary cutting blade is dimensioned to cut cardboard, and wherein the tape cutting blade is dimensioned to cut tape.

11. The utility knife of claim 7, wherein the handle is ergonomically designed.

12. A utility knife, comprising:
a housing including a handle portion and a front portion, the handle portion and the front portion;
a first wing and a second wing provided nearmost the front portion and each pivotally engaged with the handle portion, the first wing and the second wing to guide at least one blade along an edge of a box, the first wing and the second wing integrally molded to the handle portion and
a trigger to extend and retract the at least one blade between an extended position and a retracted position, wherein the extended position allows for the cutting of a material.

13. The utility knife of claim 12, wherein the handle is comprised of an interior cavity to house one or more replacement blades.

14. The utility knife of claim 13, wherein the interior cavity is selectively accessed by a release button positioned on the handle portion.

15. The utility knife of claim 14, wherein the first wing and the second wing are pivotally engaged with the handle portion.

16. The utility knife of claim 15, wherein the at least one blade include a primary cutting blade and a tape cutting blade, wherein the primary cutting blade is dimensioned to cut cardboard, and wherein the tape cutting blade is dimensioned to cut tape.

17. The utility knife of claim 16, wherein the handle is ergonomically designed.

18. The utility knife of claim 17, wherein the trigger is positioned on a top side of the handle portion.
